(19) United States
(12) Patent Application Publication
(10) Pub. No.: US 2007/0272838 A1
(43) Pub. Date: Nov. 29, 2007

(54) LIGHT SOURCE AND LIGHT SOURCE SYSTEM

(75) Inventors: Yuki Kudo, Yokohama-shi (JP); Kunio Ishida, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/684,254

(22) Filed: Mar. 9, 2007

(30) Foreign Application Priority Data
Mar. 30, 2006 (JP) P2006-95402

(51) Int. Cl. G01J 1/04

(52) U.S. Cl. 250/227.12

(57) ABSTRACT

A light source includes: a light source system includes: a light source unit producing a first pulsed light beam having a plurality of frequency components; a splitter splitting the first pulsed light beam into second and third pulsed light beams; a first photonic crystal fiber converting the split second pulsed light beam into a wider bandwidth; a second photonic crystal fiber converting the split third pulsed light beam into a wider bandwidth; a first adjuster adjusting a spectrum of the second pulsed light beam converted into the wider bandwidth; a phase adjuster matching phases of the second and third pulsed light beams converted into the wider bandwidth; and a superimposing unit superimposing the second pulsed light beam having the adjusted spectrum and the third pulsed light beam converted into the wider bandwidth.

### CROSS REFERENCE TO RELATED APPLICATIONS

This application is based upon and claims the benefit of priority from the prior Japanese Patent Application No. 2006-095402 filed on Mar. 30, 2006, the entire contents of which are incorporated herein by reference.

### BACKGROUND OF THE INVENTION

1. Field of the Invention

This invention relates to a light source and a light source system, and more specifically relates to a light source and a light source system in which photonic crystal fibers are used in order to broaden a bandwidth of a pulsed light beam and outputs a broadband pulsed light beam.

2. Description of the Related Art

The photonic fiber is known to have the micro-structure, and is used to produce white light which is broad and has continuous spectra. The spectra of the white light substantially depend upon peak power of optical pulses, i.e., the more intensive the peak of input optical pulses, the broader spectra of the white light. The photonic crystal fiber is advantageous in some respects compared to ordinary optical fiber. For instance, design zero dispersion of the photonic crystal fiber can be designed, so that it is possible to use a pulse light source whose wavelength ranges between a visible band and an infrared band. Further, the photonic crystal fiber has strong nonlinearity, which enables approximately one-meter long fiber to produce broadband white light.

JP-A 2004-287074 (KOKAI) describes a wavelength converter, in which a photonic crystal fiber is used to convert a wavelength of an incoming pulsed light beam. With the wavelength converter, the arriving pulsed light beam is split, and wavelengths of the split pulsed light beams are converted by the photonic crystal fibers.

When assessing a spectroscopic attribute such as optical absorption or Raman spectroscopy of a specimen material, a light source is required to have moderate wavelength dependency of a light intensity (differences in light intensities for respective wavelength bands). For instance, a CARS microscopy which operates on the coherent anti-Stokes Raman scattering (CARS) is used for the foregoing assessment. When the CARS microscopy is used, two or more pulsed light beams are illuminated into a specimen in order to observe CARS signals which are emitted in response to non-linear optical processes. Heavier the wavelength dependency of the light intensity of the pulsed light beams illuminated into the specimen, the more extensively light intensities of signals from the specimen tends to become variable. This means that a sensor having a large dynamic range has to be used.

For instance, pulsed light beams which are converted into broadband light by the photonic crystal fiber are used as a light source for the CARS microscopy. In such a case, it is preferable for the light intensity to have moderate wavelength dependency. FIGS. 13A, 13B and 13C, FIG. 14A, 14B and 14C, and FIG. 15A, 15B and 15C of the accompanying drawings show the relationships between input light intensities and output waveforms of pulsed light beams at photonic crystal fibers. A Ti:sapphire laser (having a central wavelength of 800 nm) is used to illuminate the light pulses, thereby producing broadband white pulsed light beams at photonic crystal fibers, which are measured. As shown in these drawing figures, the larger the power (0 mW to 170 mW) of the incoming pulsed light beams, the more moderate the wavelength dependency of the light intensity. If the input pulse is enlarged as shown in FIG. 15C, the light intensity varies approximately 10 dB to 20 dB depending upon wavelengths. In order to reduce the dependency of the light intensity, the power of incoming pulsed light beams should be increased.

The larger the power of the incoming pulsed light beams, the more easily edges of the photonic crystal fiber will be damaged. Therefore, there are limitations to reduce the wavelength dependency of outgoing pulsed light beams when increasing the power of the incoming pulsed light beams.

The present invention has been contemplated in order to overcome problems of the related art, and is intended to provide a light source and a light source system which can produce a broadband white light beam having moderate wavelength dependency of the light intensity.

### SUMMARY OF THE INVENTION

According to a first aspect of the embodiment of the invention, there is provided a light source which includes: a light source unit producing a first pulsed light beam having a plurality of frequency components; a splitter splitting the first pulsed light beam into second and third pulsed light beams; a first photonic crystal fiber converting the split second pulsed light beam into a wider bandwidth; a second photonic crystal fiber converting the split third pulsed light beam into a wider bandwidth; a first adjuster adjusting a spectrum of the second pulsed light beam converted into the wider bandwidth; a phase adjuster matching phases of the second and third pulsed light beams converted into the wider bandwidth; and a superimposing unit superimposing the second pulsed light beam having the adjusted spectrum and the third pulsed light beam converted into the wider bandwidth.

In accordance with a second aspect of the embodiment of the invention, there is provided a light source system which includes: a light source unit producing a first pulsed light beam having a plurality of frequency components; a splitter splitting the first pulsed light beam into second and third pulsed light beams; a first photonic crystal fiber converting the split second pulsed light beam into a wider bandwidth; a second photonic crystal fiber converting the split third pulsed light beam into a wider bandwidth; a first adjuster adjusting a spectrum of the second pulsed light beam converted into the wider bandwidth; a phase adjuster matching phases of the second and third pulsed light beams converted into the wider bandwidth; a superimposing unit superimposing the second pulsed light beam having the adjusted spectrum and the third pulsed light beam converted into the wider bandwidth; a sensor sensing the spectra of white light beam from the superimposing unit; and a control unit controlling the first adjuster on the basis of the spectrum detected by the sensor.

### BRIEF DESCRIPTION OF SEVERAL VIEWS OF DRAWINGS

FIG. 1 is a block diagram of a light source system according to a first embodiment of the invention;

FIG. 2A and FIG. 2B schematically show a phase adjuster of the light source system in FIG. 1;

FIG. 3A, FIG. 3B, FIG. 3C and FIG. 3D are graphs showing variations of pulsed light beams of the light source system in FIG. 1;

FIG. 4A, FIG. 4B and FIG. 4C are graphs showing variations of the pulsed light beams of the light source system in FIG. 1;

FIG. 5 is a block diagram of a light source system according to a second embodiment of the invention;

FIG. 6A and FIG. 6B schematically show a phase adjuster of the light source system in FIG. 5;

FIG. 7 is a block diagram of a light source system according to a third embodiment of the invention;

FIG. 8 is a block diagram of a light source system according to a fourth embodiment of the invention;

FIG. 9 is a block diagram of a light source system according to a fifth embodiment of the invention;

FIG. 10 is a block diagram of a light source system according to a sixth embodiment of the invention;

FIG. 11 is a block diagram of a light source system according to a seventh embodiment of the invention;

FIG. 12 is a block diagram of a light source system according to an eighth embodiment of the invention;

FIG. 13A, FIG. 13B and FIG. 13C are graphs showing the relationships between input light intensities and output waveforms of pulsed light beams at photonic crystal fibers;

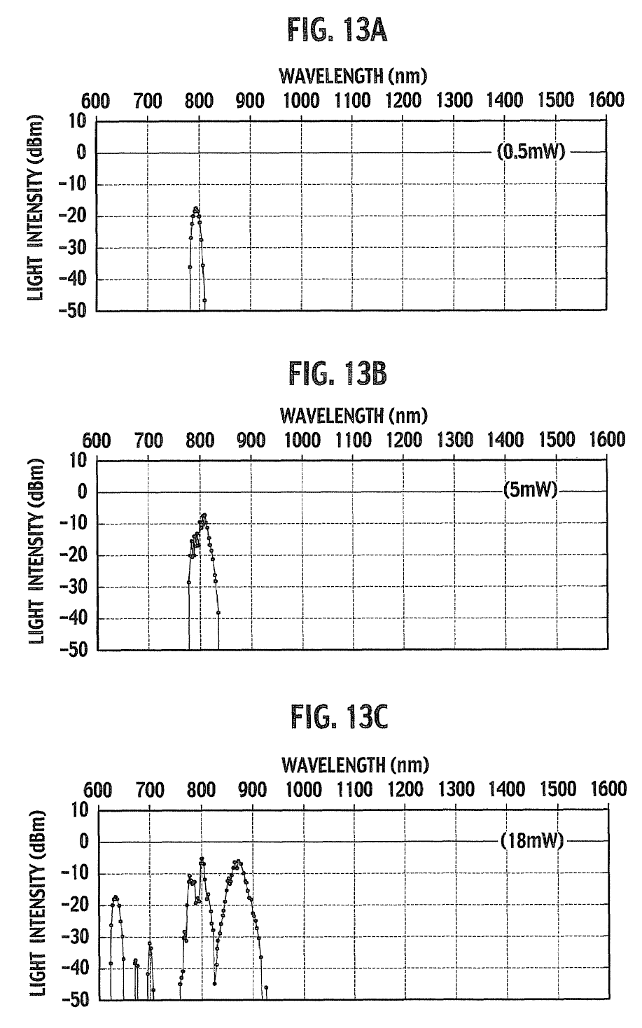

FIG. 14A, FIG. 14B and FIG. 14C are graphs showing the relationships between input light intensities and output waveforms of pulsed light beams at photonic crystal fibers: and

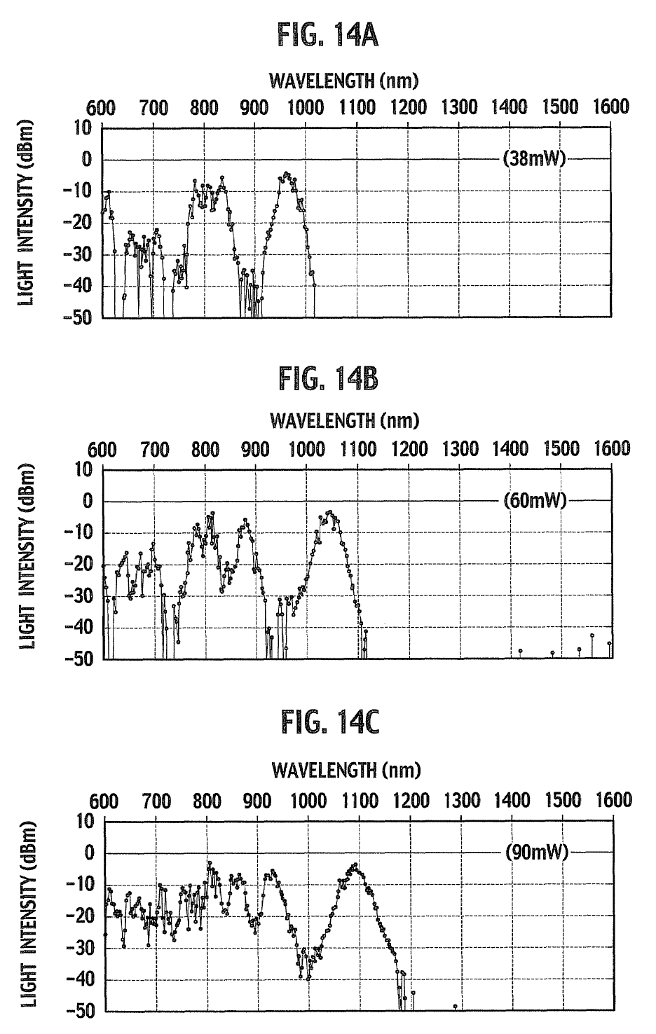

FIG. 15A, FIG. 15B and FIG. 15C are graphs showing the relationships between input light intensities and output waveforms of pulsed light beams at photonic crystal fibers.

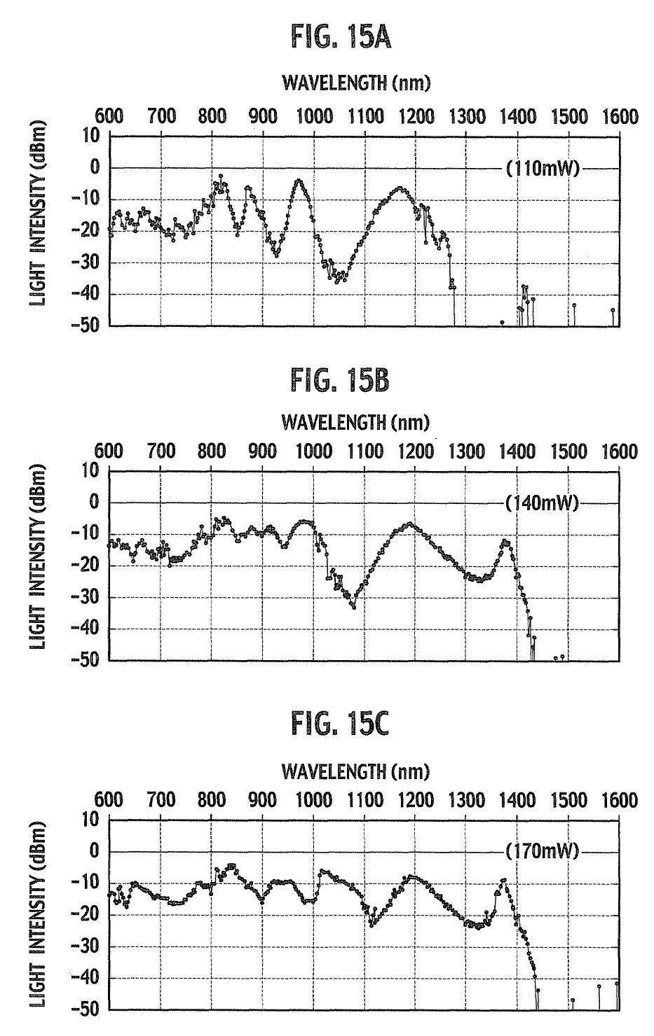

### DETAILED DESCRIPTION OF THE INVENTION

### (1) First Embodiment

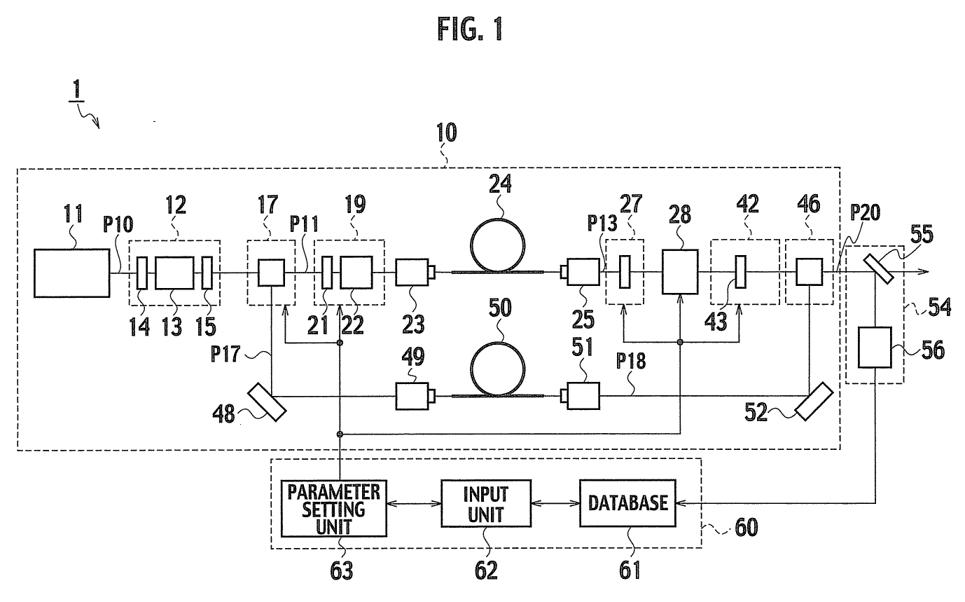

Referring to FIG. 1, a light source system 1 includes a light source 10, a sensor 54, and a control unit 60. The light source 10 converts a pulsed light beam P10 (called the “pulsed light beam P10”) into a wider bandwidth (called the “broadband white light beam P20”), and outputs the broadband white light beam P20. The sensor 54 extracts a part of the broadband white light beam P20, and detects a spectrum thereof. The control unit 60 controls components (to be described later) of the light source 10 on the basis of the spectrum detected by the sensor 54, and adjusts wavelength dependency of the broadband white light beam P20.

The light source 10 is constituted by: a short pulsed laser light source unit 11 (called the “laser light source unit 11”) which outputs femto-second to picosecond pulsed light beams: a pulsed light splitter 17 which splits the pulsed light beam P10 into a first pulsed light beam P11 and a second pulsed light beam P17 at a predetermined split ratio; an input light intensity adjuster 19 which adjusts a light intensity of the first pulsed light beam P11; the first photonic fiber 24 which receives and converts the light-intensity-adjusted first pulsed light beam P11 into a first broadband output pulsed light beam P13 (called the “first output pulsed light beam P13”); a polarizing adjuster 27 which adjusts polarization, phase and light intensity of the first broadband output pulsed light beam P13; a phase adjuster 28; an output light intensity adjuster 42; a second photonic crystal fiber 50 which receives and converts the second pulsed light beam P17 into a second broadband output pulsed light beam P18 (called the “second output pulsed light beam P18”); and a superimposing unit 46 which superimposes the second output pulsed light beam P18 on the first output pulsed light beam P13.

The laser light source unit 11 may use a Ti:sapphire laser, a fiber laser or a semiconductor laser, and has oscillation wavelengths which depend upon wavelength ranges to be outputted, and zero-dispersion wavelength of the photonic crystal fibers 24 and 50. In this embodiment, the oscillation wavelengths are between 400 nm and 1600 nm.

The light source unit 10 further includes an optical isolator 12, which is constituted by a faraday rotator 13 placed between polarizers (polarizing prism) 14 and 15, and prevents light beams, which are reflected by edges of the photonic crystal fibers 24 and 50, from being returned to the light source unit 11.

The pulsed light splitter 17 is a non-polarizing beam splitter. When making the split ratio variable, a polarizing beam splitter may be used in combination with a λ/2 wave plate. In such a case, when the λ/2 wave plate is rotated, the polarizing beam splitter changes a polarizing direction of the pulsed light beam P10 arriving at the polarizing beam splitter, thereby varying and adjusting the split ratio.

The input light intensity adjuster 19 is constituted by another λ/2 wave plate 21, and a polarizing beam splitter 22. When the λ/2 wave plate 21 is rotated, the input light intensity adjuster 19 changes a polarizing direction of the first pulsed light beam P11 to be sent to the polarizing beam splitter 22. Further, the input light intensity adjuster 19 adjusts the light intensity of the first pulsed light beam P11, and sends it to the first photonic crystal fiber 24. Alternatively, the input light intensity adjuster 19 may be a reflective ND (neutral density) filter or an iris diaphragm.

The first photonic crystal fiber 24 has at its input side an objective lens 23 whose magnifying power is 20 to 60. The magnifying power of the objective lens 23 depends upon an NA (numerical aperture) of the photonic crystal fiber 24. Further, the first photonic crystal fiber 24 is provided at its output side with an objective lens 25, which collimates the first pulsed light beam passing through the first photonic crystal fiber 24.

The polarizing adjuster 27 is constituted by a polarizing prism extracts linearly-polarized elements from the first output pulsed light beam P13 passing through the photonic crystal fiber 24, and thereby adjusts a plane of polarization of the first broadband output pulsed light beam P13 which has passed through the photonic crystal fiber 24 which is not polarization maintaining type. The first output pulsed light beam P13 is superimposed on the second output pulsed light beam P18 with matching the planes of polarization of the pulsed light beams P18 and P13. The second output pulsed light beam P18 has passed through the second photonic crystal fiber 50.

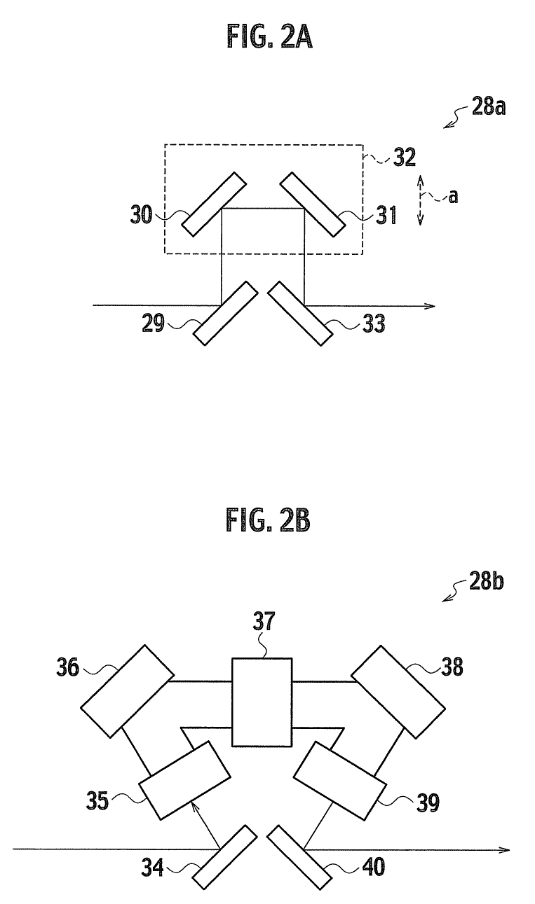

The phase adjuster 28 adjusts the phase of the first output pulsed light beam P13, and includes a first adjusting unit 28a and a second adjusting unit 28b. The first adjusting unit 28a is provided with four mirrors 29, 30, 31 and 33 (for instance) which are variably spaced from one another as shown in FIG. 2A, and roughly adjusts a phase of the first output pulsed light beams P13. The second adjusting unit 28b includes a diffraction grating and a spatial light modulator, and finely adjusts a phase of the first output pulsed light beams P13 with respect to each frequency as shown in FIG. 2B. Alternatively, the phase adjuster 28 may be a chirp mirror.

Referring to FIG. 2A, the four mirrors 29, 30, 31 and 33 reflect and transmit the first output pulsed light beam P13 one after another. Specifically, the mirrors 30 and 31 are movable in a direction shown by an arrow a in unison, thereby adjusting the phase of the first output pulsed light beam P13 by varying a length of a light path.

The second adjusting unit 28b (shown in FIG. 2B) receives the first output pulsed light beam P13 via a mirror 34 from the first adjusting unit 28a, and reflects the first output pulsed light beams P13, and transmits it to a lens 35. The first output pulsed light beam P13 passing via the lens 35 is incident onto the grating lattice 36. The grating lattice 38 splits the incident pulsed light beam in accordance with wavelengths, and transmits the split light beams to the spatial optical modulator 37. The spatial optical modulator 37 adjusts phases of the split light beams in accordance with the wavelengths. The grating lattice 38 groups the phase-adjusted light beams from the spatial optical modulator 37 according to the wavelengths, and transmits them to an output light intensity adjuster 42 (shown in FIG. 1) via a lens 39 and a mirror 40.

The output light intensity adjuster 42 is constituted by a reflective ND filter 43, and adjusts a light intensity of the first output pulsed light beam P13 arriving via the first photonic crystal fiber 24. Alternatively, the output light intensity adjuster 42 may be constituted by an iris diaphragm and a beam expander for adjusting a beam diameter, or a λ/2 wave plate and a polarizing beam splitter.

The second photonic crystal fiber 50 is identical to the first photonic crystal fiber 24, and has on an input side thereof an objective lens 49 whose magnifying power is 20 to 60. The magnifying power of the objective lens 49 depends upon an NA of the photonic crystal fiber 50. Further, the second photonic crystal fiber 50 includes at its output side an objective lens 51, which collimates the light beam passing through the second photonic crystal fiber 50.

A mirror 48 is placed between the pulsed light splitter 17 and the objective lens 49, and guides to the objective lens 49 the second pulsed light beam P17 (which has been split by the pulsed light splitter 17). Further, a mirror 52 is placed between the objective lens 51 and the superimposing unit 46, and guides the second output pulsed light beam P18 from the objective lens 51 to the superimposing unit 46.

The superimposing unit 46 may be a beam splitter or a mirror.

The sensor 54 includes a beam splitter 55 and a spectrum sensor 56. The beam splitter 55 extracts a part of the broadband white light beam P20 which is produced by superimposing the first and second output pulsed light beams P13 and P18. The spectrum sensor 56 detects a spectrum of the light beam extracted by the beam splitter 55.

The control unit 60 includes a database 61, an input unit 62, and a parameter setting unit 63. The database 61 stores the spectrum of the broadband white light beam P20 (detected by the sensor 54) in correspondence with a variety of parameters of the pulsed light splitter 17, input light intensity adjuster 19, polarizing adjuster 27, phase adjuster 27 and output light intensity adjuster 42. The input unit 62 receives information concerning a wavelength band, a light intensity and wavelength dependency of the broadband white light beam P20. The parameter setting unit 63 retrieves from the database 61 a spectrum (which substantially meets input conditions) on the basis of the wavelength band, light intensity, wavelength dependency and so on received via the input unit 62. Further, the parameter setting unit 63 selects the parameters which correspond to the retrieved spectrum, and provides them to the pulsed light splitter 17, input light intensity adjuster 19, polarizing adjuster 27, phase adjuster 28, and output light intensity adjuster 42.

If the pulsed light splitter 17 is constituted by the λ/2 wave plate and a polarizing beam splitter in order to adjust a split ratio, a rotation angle of the λ/2 wave plate is set as a parameter. Further, if the input light intensity adjuster 19 is constituted by the λ/2 wave plate and a polarizing beam splitter in order to adjust a light intensity, the rotation angle of the λ/2 wave plate is set as a parameter. Still further, if the polarizing adjuster 27 is provided with a polarizing prism in order to adjust a plane of polarization, a direction of a polarizing axis of the polarizer is set as a parameter. Still further, if the phase adjuster 28 uses the first adjusting unit 28a (shown in FIG. 2A) and the second adjusting unit 28b (shown in FIG. 2B) in order to conduct phase adjustment, not only the positions of the mirrors 30 and 31 of the first adjusting unit 28a but also a phase-controlled amount of the spatial optical modulator 37 of the second adjusting unit 28b are set as parameters. If the output light intensity adjuster 42 adjusts the light intensity using the reflective ND filter 43, a rotation angle of the reflective ND filter 43 is set as a parameter.

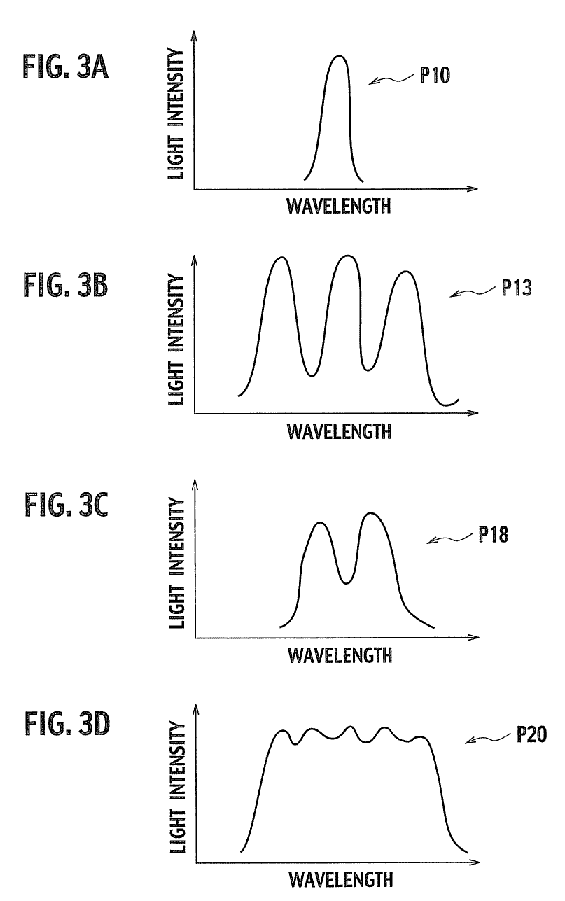

In the light source unit 10, the pulsed light beam P10 (shown in FIG. 3A) emitted by the light source unit 11 are split into the first and second pulsed light beams P11 and P17 by the pulsed light splitter 17.

The first pulsed light beam P11 has its light intensity adjusted by the input light intensity adjuster 19 upstream of the first photonic crystal fiber 24, the first. After passing through the first photonic crystal fiber 24, the first pulsed light beam P11 is converted into the first output pulsed light beam P13, which has a width-changed spectrum and a broadened bandwidth. In other words, when the light intensity is reduced upstream of the first photonic crystal fiber 24, the spectral width of the first output pulsed light beam P13 is reduced. On the contrary, if the light intensity is raised at the incoming side, the spectral width of the first output pulsed light beams P13 will be increased.

The polarizing adjuster 27 converts the first output pulsed light beam P13 into a linearly-polarized light beam having a certain plane of polarization. Therefore, even if the plane of polarization of the first output pulsed light beam P13 (which has passed through the first photonic crystal fiber 24 (not of the polarization maintaining type)) rotates, the second output pulsed light beam P18 can be superimposed on the first output pulsed light beams P13 with the planes of polarization matching with each other. In the first embodiment, the second photonic crystal fiber 50 is not of the polarization maintaining type. Even if the plane of polarization of the second output pulsed light beam P18 passing through the second photonic crystal fiber 50 rotates, the first output pulsed light beam P13 has its plane of polarization adjusted by the polarizing adjuster 27. Therefore, the planes of polarization of the light beams P18 and P13 can be made to match with each other.

The phase adjuster 28 adjusts the phase of the first output pulsed light beam P13 whose plane of polarization has been adjusted by the polarizing adjuster 27. The phases of the first output pulsed light beam P13 and the second output pulsed light beam P18 are made to agree with each other. Therefore, the first and second output pulsed light beams P13 and P18 are superimposed with the phase information maintained. The spectrum of the superimposed broadband white light beam P20 can be controlled by the input light intensity adjuster 19.

The first pulsed light beam P11 whose light intensity has been adjusted, thereby the first output pulsed light beam P13 passing through the first photonic crystal fiber 24 has its spectrum converted. The first output pulsed light beam P13 (shown in FIG. 3B) and the second output pulsed light beam P18 (shown in FIG. 3C) passing through the second photonic crystal fiber 50 are superimposed, so that the broadband white light beam P20 having moderate wavelength dependency of the light intensity (refer to FIG. 3D) will be produced. In other words, before passing through the first photonic crystal fiber 24, the light intensity of the first pulsed light beam P11 is adjusted by the input light intensity adjuster 19, which enables adjustment of the spectrum of the first output pulsed light beam P13 after it passes through the first photonic crystal fiber 24. Therefore, it is possible to adjust the spectrum of the broadband white light beam P20.

In the first embodiment, the short pulsed laser light source unit 11 is employed. The pulsed light beam P10 transmitted from the short pulsed laser light source 11 has the phase information, which is different from a light beam from a fluorescent material or an LED. Specifically, the pulsed light beam P10 includes a plurality of frequency elements which maintain a phase relationship each other. Further, the first and second output pulsed light beams P13 and P18 which have passed through the first and second photonic crystal fibers 24 and 50 have the phase information. The phase adjuster 28 matches the phase of the first output pulsed light beam P13 to the phase of the second output pulsed light beam P18, so that it is possible to produce the broadband white light beam P20 having the phase information and moderate wavelength dependency of the light intensity. By using the broadband white light beam P20 in which phase relationship between frequencies is maintained, information such as vibration energy of an item to be analyzed can be efficiently reviewed when an object is to be analyzed using the CARS or the like.

With the first embodiment, it is possible to produce the broadband white light beam P20 having the phase information and moderate wavelength dependency of the light intensity. Further, it is possible to suppress variations of an intensity of a signal detected from an object to be analyzed. Therefore, the sensor having a small dynamic range can be used.

### FIRST EXAMPLE

In this example, the laser light source unit 11 is a Ti:sapphire laser. The pulsed light beams P10 have a central wavelength of 800 nm, a pulse width of 100 fs (100 femto-seconds), and an average light intensity of 400 mW. The optical isolator 12 is constituted by the faraday rotator and a polarizer. The pulsed light splitter 17 splits, using the beam splitter, the pulsed light beam P10 into two pulsed light beams P11 and P17 whose average light intensity is 200 mW. The light intensity of the split pulsed light beams is adjusted by the polarizing beam splitter 22 and λ/2 wave plate 21. Thereafter, the light-intensity-adjusted pulsed light beam P11 is input into the first photonic crystal fiber 24 via the objective lens 49 of 40 magnifications, and is converted into a first output pulsed light beam P13. The first photonic crystal fiber 24 is of refractive index guide type, has large nonlinearity, and is one meter long. The polarization, phase and light intensity of the first output pulsed light beam P13 from the first photonic crystal fiber 24 are adjusted. Thereafter, the first output pulsed light beam P13 is spatially and timewise superimposed on the second output pulsed light beam P18 arriving from the second photonic crystal fiber 50. The polarizing adjuster 27 extracts, using the polarizing prism, linearly-polarized elements from the first output pulsed light beam P13. The phase adjuster 27 adjusts positions of the mirrors 30 and 31, and roughly adjusts the phase of the first output pulsed light beam P13, as shown in FIG. 2A. If the phase cannot be reliably adjusted, it is finely adjusted with respect to respective frequencies using the grating lattices 36 and 38, and the spatial optical modulator 37 as shown FIG. 2B. The output light intensity adjuster 42 is the reflective ND filter 43, and the superimposing unit 46 is a beam splitter.

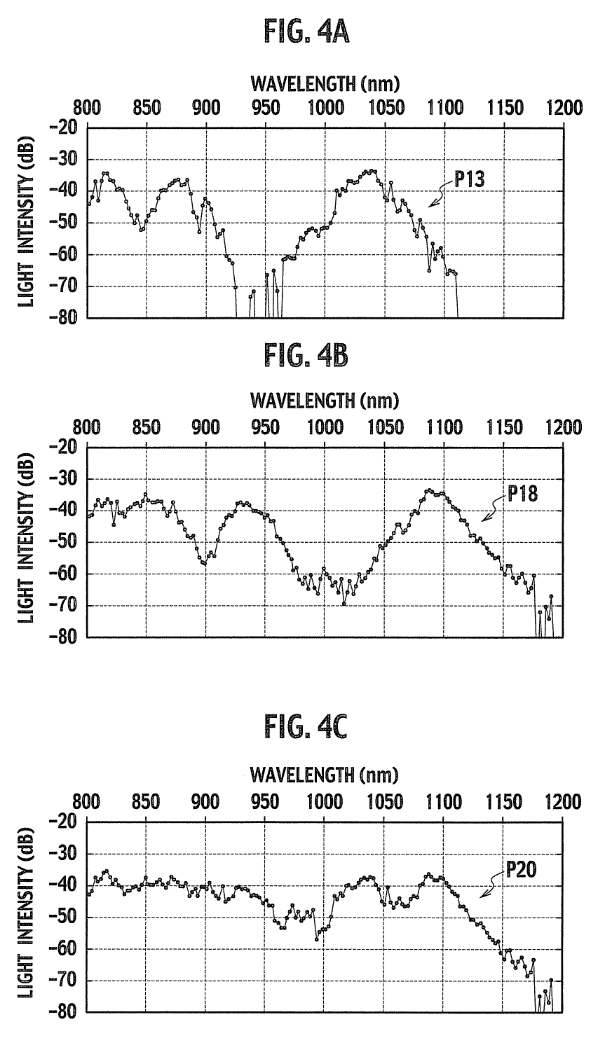

The spectrum of the first output pulsed light beam P13 from the first photonic crystal fiber 24 is shown in FIG. 4A. The spectrum of the second output pulsed light beam P18 from the second photonic crystal fiber 50 is shown in FIG. 4B. The spectrum of the broadband white light beam P20 superimposed by the superimposing unit 46 is shown in FIG. 4C. By changing the light intensity of the first pulsed light beam P11 arriving at the first photonic crystal fiber 24, the spectrum of the first output pulsed light beam P13 transmitted from the first photonic fiber 24 can be converted. When the first and second output pulsed light beams P13 and P18 are superimposed, the broadband white light beam P20 having phase information as well as moderate wavelength dependency of the light intensity and can be produced.

### (2) Second Embodiment

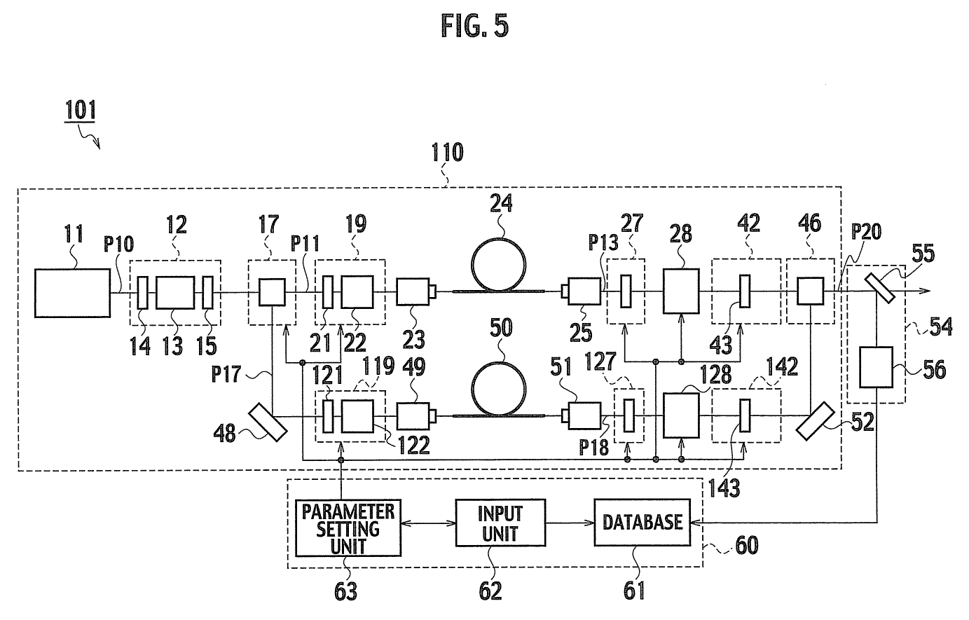

Referring to FIG. 5, a light source system 101 is similar to the light source system 1 shown in FIG. 1, but is different in the following respects: the light intensity of the second pulsed light beam P17 is adjusted at the upstream of the second photonic crystal fiber 50; and the polarization, phase and light intensity of the second output pulsed light beam P18 which has passed through the second photonic crystal fiber 50 are adjusted.

A light source unit 110 of the light source system 101 includes an input light intensity adjuster 119 which is placed upstream of the second photonic crystal fiber 50 and adjusts an input light intensity of the second pulsed light beam P17 split by the pulsed light splitter 17; a polarizing adjuster 127; a phase adjuster 128; and an output light intensity adjuster 142. These adjusters are placed downstream of the second photonic crystal fiber 50 and adjust the polarization, phase and light intensity of the second broadband output pulsed light beam P18.

The input light intensity adjuster 119, polarizing adjuster 127, phase adjuster 128 and output light intensity adjuster 142 are configured similarly to the input light intensity adjuster 19, polarizing adjuster 27, phase adjuster 28 and output light intensity adjuster 42 which are positioned upstream and downstream of the first photonic crystal fiber 24.

The input light intensity adjuster 119 includes a λ/2 wave plate 121 and a polarizing beam splitter 122, and rotates the λ/2 wave plate 121 in order to change a polarizing direction of the second pulsed light beam P17 arriving at the beam splitter 122, and adjusts the light intensity of the second pulsed light beam P17 which is destined to the second photonic crystal fiber 50 from the polarizing beam splitter 122. Alternatively, the input light intensity adjuster 119 may be a reflective ND filter or an iris diaphragm.

The polarizing adjuster 127 is constituted by a polarizing prism, extracts linearly-polarized elements from the second output pulsed light beam P18 which has passed through the second photonic crystal fiber 50, and adjusts a plane of polarization of the second output pulsed light beam P18 which rotates while passing through the second photonic crystal fiber 50 of not the polarization maintaining type. Therefore, the second output pulsed light beam P18 can be superimposed on the polarized plane of the first output pulsed light beam P13 passing through the first photonic crystal fiber 24 with the planes of polarization matching with each other.

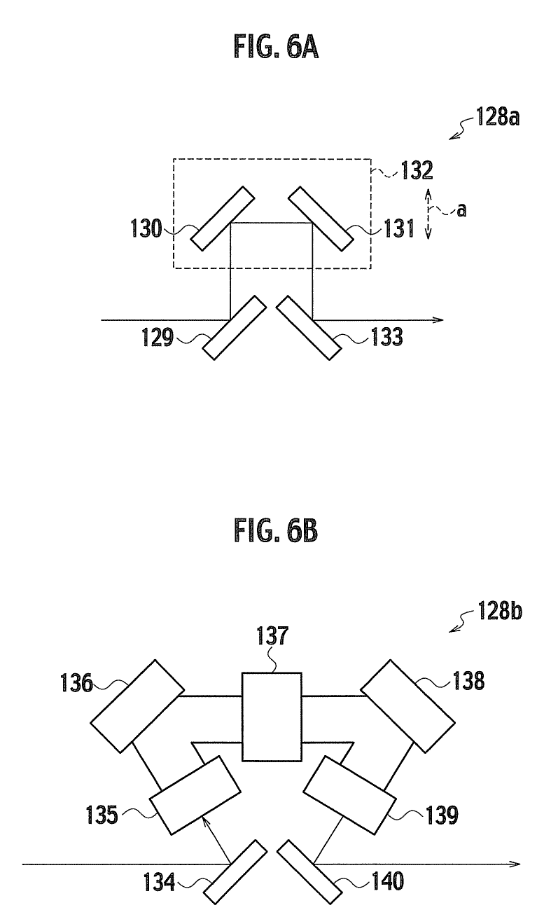

The phase adjuster 128 includes a first adjusting unit 128a and a second adjusting unit 128b. The first adjusting unit 128a is provided with four mirrors 129, 130, 131 and 133 which are variably spaced from one another as shown in FIG. 6A, and roughly adjusts a phase of the second output pulsed light beam P18. The second adjusting unit 128b includes a diffraction grating and a spatial light modulator, and finely adjusts the phase of the pulsed light beam P18 for each frequency as shown in FIG. 6B. In short, the phase adjuster 128 adjusts phase of the second output pulsed light beam P18. Alternatively, the phase adjuster 128 may be a chirp mirror.

Referring to FIG. 6A, the four mirrors 129, 130, 131 and 133 reflect and transmit the second output pulsed light beam P18 one after another. Specifically, the mirrors 130 and 131 are movable in a direction shown by an arrow a in unison, thereby adjusting the phase of the pulsed light beam P18 by varying a length of a light path.

The second adjusting unit 128b (shown in FIG. 6B) receives and reflects the second output pulsed light beam P18 from the first adjusting unit 128a via a mirror 134, and transmits the reflected second output pulsed light beam P18 to a lens 135. The pulsed light beam P18 passing via the lens 135 is incident onto the grating lattice 136. The grating lattice 136 splits the pulsed light beam P18 in accordance with wavelengths, and transmits the split light beams to the spatial optical modulator 137. The spatial optical modulator 137 adjusts the phases of the split light beams in accordance with the wavelengths. The grating lattice 138 groups the phase-adjusted light beams according to the wavelengths, and transmits them to an output light intensity adjuster 142 (shown in FIG. 5) via a lens 139 and a mirror 140.

The output light intensity adjuster 142 is constituted by the reflective ND filter 143, and adjusts the light intensity of the second output pulsed light beam P18 arriving via the second photonic crystal fiber 50. Alternatively, the output light intensity adjuster 142 may be constituted by an iris diaphragm and a beam expander for adjusting a beam diameter, or the λ/2 wave plate and a polarizing beam splitter.

With the light source unit 110, the first and second pulsed light beams P13 and P18 are superimposed after their spectra are adjusted, so that the spectrum of the broadband white light beam P20 can be further easily controlled.

With the second embodiment, it is possible to produce the broadband white light beam P20 having the phase information and moderate wavelength dependency of the light intensity. Further, it is possible to suppress variations of a signal intensity of a signal detected from an object to be analyzed. Therefore, the sensor having a small dynamic range can be used.

The control unit 60 includes the database 61, input unit 62, and parameter setting unit 63. The database 61 stores a spectrum of the broad band white light beams P20 (detected by the sensor 54) in correspondence with a variety of parameters of the pulsed light splitter 17, input light intensity adjuster 19, 119, polarizing adjuster 27, 127, phase adjuster 28, 128 and output light intensity adjuster 42, 142. The foregoing parameters are those obtained when the desired spectrum is accomplished. The input unit 62 receives information concerning a wavelength band, a light intensity and wavelength dependency of the broadband white light beam P20. The parameter setting unit 63 retrieves from the database 61 a spectrum (which substantially meets input conditions) on the basis of the wavelength band, light intensity, wavelength dependency and so on received via the input unit 62. Further, the parameter setting unit 63 selects the parameters which correspond to the retrieved spectrum, and provides them to the pulsed light splitter 17, input light intensity adjuster 19, 119, polarizing adjuster 27, 127, phase adjuster 28, 128 and output light intensity adjuster 42, 142. Therefore, the broadband white light beam P20 meets requirements entered via the input unit 62.

### (3) Third Embodiment

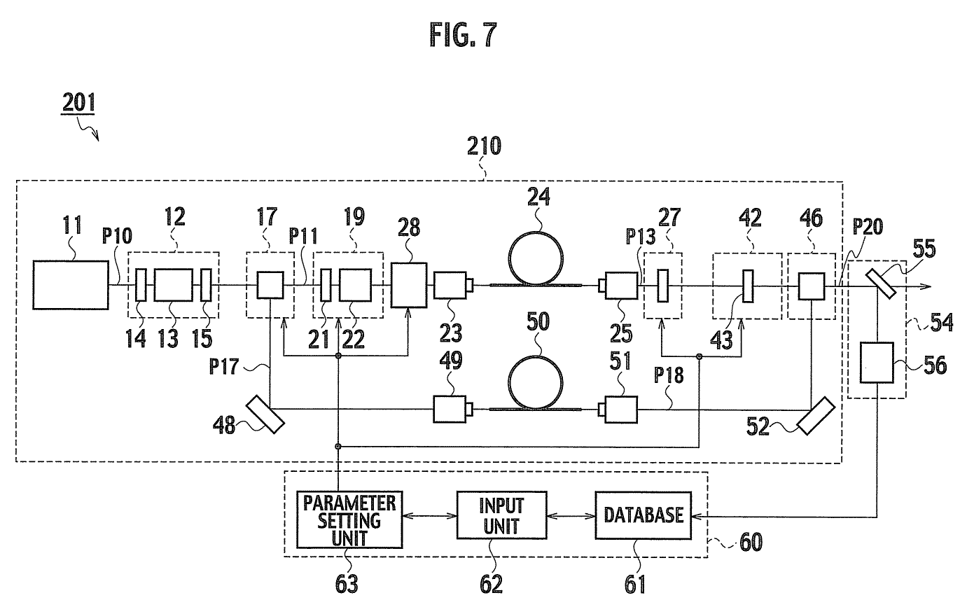

Referring to FIG. 7, a light source system 201 is similar to the light source system 1 (shown in FIG. 1) except for the position of the phase adjuster 28.

In a light source unit 210 in FIG. 7, the phase adjuster 28 is placed upstream of the first photonic crystal fiber 24 in place of downstream of the first photonic crystal fiber 24 in the light source 10 (shown in FIG. 1).

The phase adjuster 28 includes a first adjusting unit 28a and a second adjusting unit 28b. The first adjusting unit 28a is provided with four mirrors which are variably spaced from one another as shown in FIG. 2A, and roughly adjusts a phase of the incoming light beam (i.e., first output pulsed light beam P11). The second adjusting unit 28b includes diffraction gratings 36 and 38 (shown in FIG. 2B) and a spatial light modulator 37 (shown in FIG. 2B), and finely adjusts the phase of the pulsed light beam P11 with respect to each frequency. The phase adjuster 28 adjusts the phase of the first output pulsed light beam P11 whose light intensity has been adjusted by the input light intensity adjuster 19. If the a pulse width of the first output pulsed light beam P11 is pico-seconds and has a narrow spectrum, the second adjusting unit 28b may not be provided with the grating lattices 36 and 38.

The first pulsed light beam P11 whose phase has been adjusted passes through the first photonic crystal fiber 24, is converted into a broadband light beam with its phase maintained as it is, and is transmitted as the first output pulsed light beam P13.

The first output pulsed light beam P13 whose phase has been adjusted as described and is transmitted via the first photonic crystal fiber 24 can be made to match with the phase of the second output pulsed light beam P18 which is transmitted via the second photonic crystal fiber 50. The pulsed light beams P13 and P18 are superimposed with the phase information maintained. Therefore, the broadband white light beam P20 produced by the superimposed pulsed light beams P13 and P18 can have the spectrum thereof adjusted by the input light intensity adjuster 19.

Further, since the phase the first pulsed light beam P11 is adjusted before passing through the first photonic crystal fiber 24, the spectrum of the first output pulsed light beam P13 from the first photonic crystal fiber 24 can be also changed.

With the third embodiment, it is possible to produce the broadband white light beam P20 having the phase information and moderate wavelength dependency of the light intensity. It is possible to suppress variations of signal intensity of a signal detected from an object to be analyzed. Therefore, the sensor having a small dynamic range can be used.

### (4) Fourth Embodiment

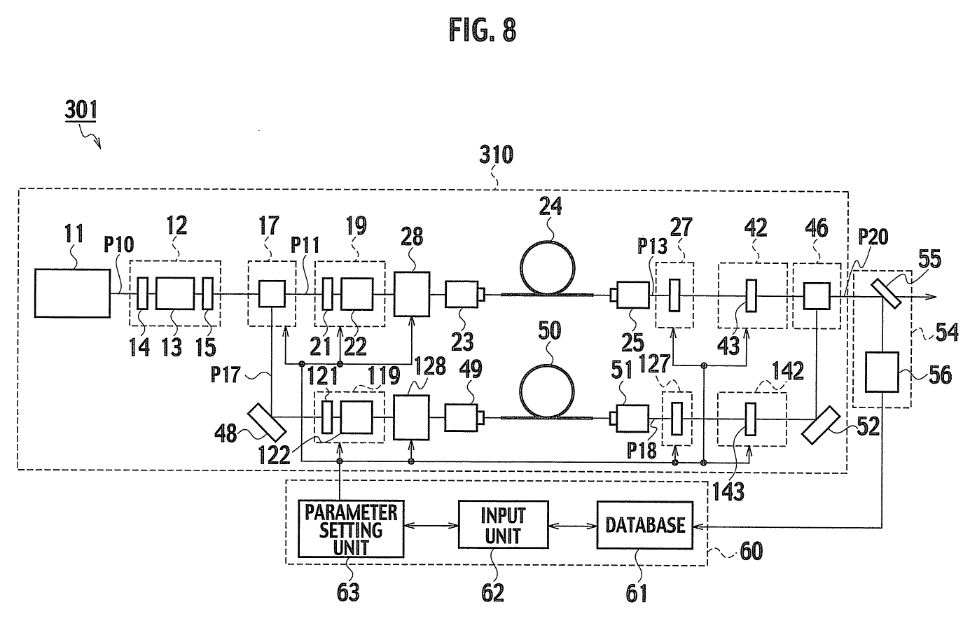

Referring to FIG. 8, a light source system 301 is similar to the light source system 201 (shown in FIG. 7), but is different in the following respects: the light intensity and phase of the second pulsed light beam P17 are adjusted in place of upstream of the second photonic crystal fiber 50; and it is possible to adjust the polarization and light intensity of the second output pulsed light beam P18 passing through the second photonic crystal fiber 50.

A light source unit 310 shown in FIG. 8 further includes an input light intensity adjuster 119, and a phase adjuster 128 which adjusts the input light intensity and phase of the second pulsed light beam P17 split by the pulsed light splitter 17; and a polarizing adjuster 127 and an output light intensity adjuster 142 which adjust the polarization and light intensity of the second output pulsed light beam P18 which has been broadened via the second photonic crystal fiber 50.

The input light intensity adjuster 119, polarizing adjuster 127, phase adjuster 128 and output light intensity adjuster 142 are configured similarly to the input light intensity adjuster 19, polarizing adjuster 27, phase adjuster 28 and output light intensity adjuster 42 which are positioned at the system of the first photonic crystal fiber 24.

The input light intensity adjuster 119 includes the λ/2 wave plate 121 and a polarizing beam splitter 122, and rotates the λ/2 wave plate 121 in order to change a polarizing direction of the second pulsed light beam P17 arriving at the beam splitter 122, and adjusts the light intensity of the second pulsed light beam P17 which is transmitted from the polarizing beam splitter 122 to the second photonic crystal fiber 50. Alternatively, the input light intensity adjuster 119 may be a reflective ND filter or an iris diaphragm.

The phase adjuster 128 includes a first adjusting unit 128a and a second adjusting unit 128b. The first adjusting unit 128a is provided with four mirrors 129, 130, 131 and 133 which are variably spaced from one another as shown in FIG. 6A, and roughly adjusts a phase of the second pulsed light beam P17. The second adjusting unit 128b includes a diffraction grating and a spatial light modulator, and finely adjusts the phase of the pulsed light beam P17 with respect to each frequency as shown in FIG. 6B. In short, the phase adjuster 128 adjusts the phase of the second pulsed light beam P17 whose light intensity has been adjusted by the light intensity adjuster 119. Alternatively, the phase adjuster 128 may be a chirp mirror.

The mirrors 129 to 133 of the first adjuster 128a (FIG. 6A) reflects and outputs one after another the second pulsed light beam P17 whose light intensity has been adjusted by the input light intensity adjuster 119. The mirrors 129, 130, 131 and 133 are moved in a direction a in unison, change an optical length of the second pulsed light beam P17, and adjust the phase of the second pulsed light beam P17.

The second adjusting unit 128b receives and reflects, via a mirror 134, the second pulsed light beam P17 whose phase has been adjusted, and guides the second pulsed light beam P17 to a lens 135. The second pulsed light beam P17 is transmitted to a grating lattice 136. The grating lattice 136 splits the received second pulsed light beam P17 in accordance with wavelengths, and transmits the split second pulsed light beams to a spatial modulator 137. The spatial modulator 137 adjusts phases of the split light beams. A grating lattice 138 groups the phase-adjusted light beams according to the wavelengths, and transmits them to the objective lens 49 of the second photonic crystal fiber 50 via the lens mirror 139 and mirror 140.

The polarizing adjuster 127 is constituted by a polarizing prism, extracts linearly-polarized elements from the second output pulsed light beam P18 which has passed through the second photonic crystal fiber 50, and adjusts a plane of polarization of the second output pulsed light beam P18 which rotates while passing through the second photonic crystal fiber 50 of not the polarization maintaining type. Therefore, the second output pulsed light beam P18 can be superimposed on the first output pulsed light beam P13 passing through the first photonic crystal fiber 24 with the planes of polarization matching with each other.

The output light intensity adjuster 142 is constituted by the reflective ND filter 143, and adjusts the light intensity of the second output pulsed light beam P18 arriving via the second photonic crystal fiber 50. Alternatively, the output light intensity adjuster 142 may be constituted by an iris diaphragm and a beam expander for adjusting a beam diameter, or the λ/2 wave plate and a polarizing beam splitter.

The phase-adjusted first output pulsed light beam P13 is transmitted via the first photonic crystal fiber 24 can be made to match with the phase of the phase-adjusted second output pulsed light beam P18 which is transmitted via the second photonic crystal fiber 50. The pulsed light beams P13 and P18 are superimposed with the phase information maintained. Therefore, the broadband white light beam P20 produced by the superimposed pulsed light beams P13 and P18 can have the spectrum thereof precisely adjusted by the input light intensity adjusters 19 and 119.

Further, the phases of the first and second pulsed light beams P11 and P17 are adjusted before passing through the first and second photonic crystal fibers 24 and 50, so that the spectrum of the first and second output pulsed light beams P13 and P18 output from the first and second photonic crystal fiber 24 and 50 can be also converted.

With the fourth embodiment, it is possible to produce the broadband white light beam P20 having the phase information and moderate wavelength dependency of the light intensity. It is possible to suppress variations of signal intensity of a signal detected from an object to be analyzed. Therefore, the sensor having a small dynamic range can be used.

The control unit 60 includes the database 61, input unit 62, and parameter setting unit 63. The database 61 stores a spectrum of the broad band white light beams P20 (detected by the sensor 54) in correspondence with a variety of parameters of the pulsed light splitter 17, input light intensity adjuster 19, 119, phase adjuster 28, 128, polarizing adjuster 27, 127 and output light intensity adjuster 42, 142. The foregoing parameters are those obtained when the desired spectrum is accomplished. The input unit 62 receives information concerning a wavelength band, a light intensity and wavelength dependency of the broadband white light beam P20. The parameter setting unit 63 retrieves from the database 61 a spectrum (which substantially meets input conditions) on the basis of the wavelength band, light intensity, wavelength dependency and so on received via the input unit 62. Further, the parameter setting unit 63 selects the parameters which correspond to the retrieved spectrum, and provides them to the pulsed light splitter 17, input light intensity adjuster 19, 119, polarizing phase adjuster 28, 128, adjuster 27, 127 and output light intensity adjuster 42, 142. Therefore, the broadband white light beam P20 meets requirements entered via the input unit 62.

### (5) Fifth Embodiment

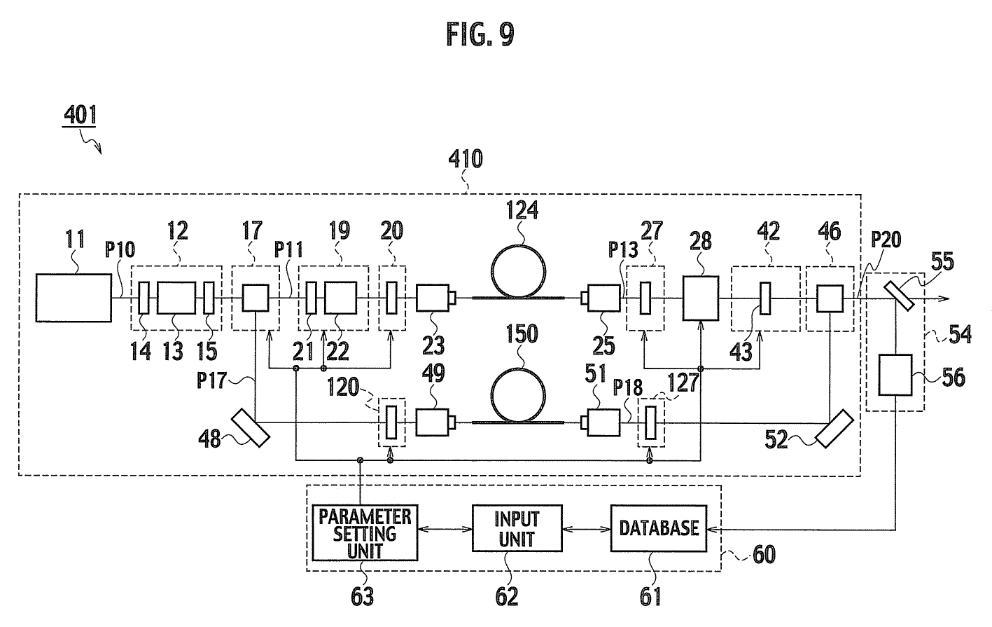

As shown in FIG. 9, a light source system 401 is similar to the light source system 1 (shown in FIG. 1) except for the following: first and second photonic crystal fibers 124 and 150 are of the polarization maintaining type; polarizing adjusters 20 and 120 are placed upstream of the first and second photonic crystal fibers 124 and 150; and a polarizing adjuster 127 is placed downstream of the second photonic crystal fiber 150.

The polarizing adjuster 20 is constituted by the; λ/2 wave plate, changes a polarizing direction of the first pulsed light beam P11 in accordance with the polarization maintaining direction of the first photonic crystal fiber 124. Further, it is possible to change a spectrum of a first output pulsed light beam P13 transmitted from the first photonic crystal fiber 124.

The polarizing adjuster 120 is constituted by the λ/2 wave plate, changes a polarizing direction of a second pulsed light beam P17 in accordance with the polarization maintaining direction of the second photonic crystal fiber 150, so that it is possible to change a spectrum of a second output pulsed light beam P18 transmitted via the second photonic crystal fiber 150.

The polarizing adjuster 127 is placed downstream of the second photonic crystal fiber 150. The polarizing adjuster 127 is constituted by the polarizing prism, extracts linearly-polarized elements from the second output pulsed light beam P18 which has passed through the second photonic crystal fiber 150, and adjusts a plane of polarization of the second output pulsed light beam P18. Therefore, the second output pulsed light beam P18 can be superimposed on the first output pulsed light beam P13 passing through the first photonic crystal fiber 124 with the planes of polarization matching with each other. Alternatively, the polarizing adjuster 127 may be omitted. In such a case, the planes of polarization of the pulsed light beams P13 and P18 may be adjusted only by the polarizing adjuster 27 placed downstream of the first photonic crystal fiber 124, thereby matching the planes of polarization of the pulsed light beams P13 and P18.

Further, the planes of polarization of the pulsed light beams P11 and P17 are adjusted by the polarizing adjusters 20 and 120 placed upstream of the first and second photonic crystal fibers 124 and 150. Therefore, it is possible to control the spectra of the first and second output pulsed light beams P13 and P18 output from the first and second photonic crystal fibers 124 and 150.

In the fifth embodiment, the first and second photonic crystal fibers 124 and 150 are the polarization maintaining type. The spectra of the light beam P13 is adjusted by the input light intensity adjuster 19, phase adjuster 28 and output light intensity adjuster 42. Further, the spectra of the light beams P13 and P18 are controlled by the polarizing adjusters 20 and 120. Therefore, the broadband white light beam P20 produced by the superimposed light beams P13 and P18 can have the spectrum of which wavelength dependency is more moderate than that of the first output pulsed light beam P13 transmitted via the first photonic crystal fiber 124.

With the fifth embodiment, it is possible to produce the broadband white light beam P20 having the phase information and moderate wavelength dependency of the light intensity. It is possible to suppress variations of signal intensity of a signal detected from an object to be analyzed. Therefore, the sensor having a small dynamic range can be used.

The control unit 60 includes the database 61, input unit 62, and parameter setting unit 63. The database 61 stores a spectrum of the broad band white light beams P20 (detected by the sensor 54) in correspondence with a variety of parameters of the pulsed light splitter 17, input light intensity adjuster 19, polarizing adjusters 20, 120, polarizing adjuster 27,127, phase adjuster 28, output light intensity adjuster 42. The foregoing parameters are those obtained when the desired spectrum is accomplished. The input unit 62 receives information concerning a wavelength band, a light intensity and wavelength dependency of the broadband white light beam P20. The parameter setting unit 63 retrieves from the database 61 a spectrum (which substantially meets input conditions) on the basis of the wavelength band, light intensity, wavelength dependency and so on received via the input unit 62. Further, the parameter setting unit 63 selects the parameters which correspond to the retrieved spectrum, and provides them to the pulsed light splitter 17, input light intensity adjuster 19, polarizing adjusters 20, 120, polarizing adjuster 27,127, phase adjuster 28, output light intensity adjuster 42. Therefore, the broadband white light beam P20 meets requirements entered via the input unit 62.

### (6) Sixth Embodiment

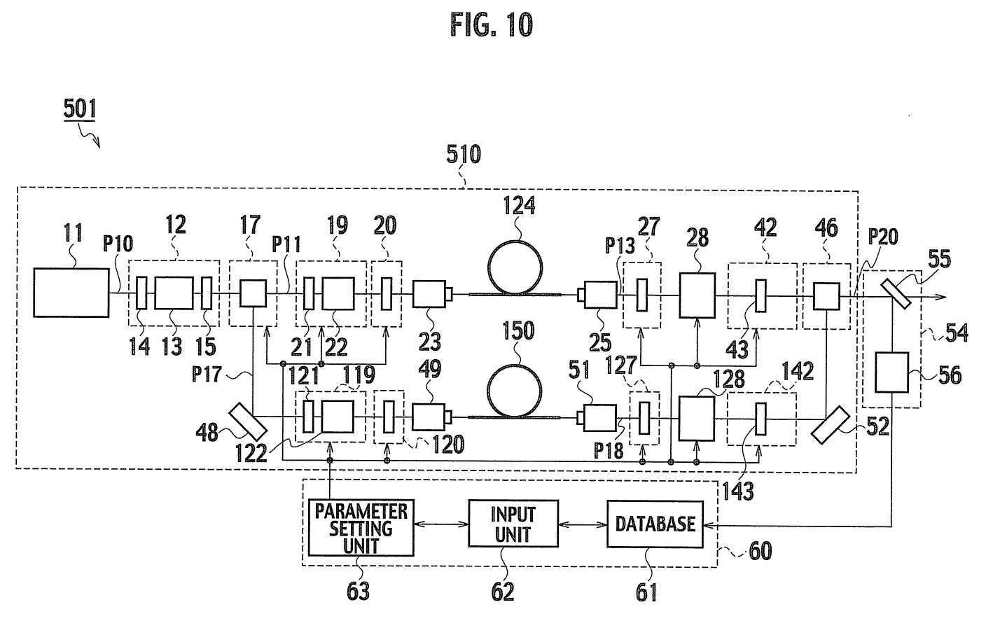

As shown in FIG. 10, a light source system 501 is similar to the light source system 101 (shown in FIG. 5) except for the following: first and second photonic crystal fibers 124 and 150 are of the polarization maintaining type; polarizing adjusters 20 and 120 are placed upstream of the first and second photonic crystal fibers 124 and 150; and a polarizing adjuster 127 is placed downstream of the second photonic crystal fiber 150.

The polarizing adjuster 20 is constituted by the λ/2 wave plate, changes a polarizing direction of the first pulsed light beam P11 in accordance with the polarization maintaining direction of the first photonic crystal fiber 124. Further, it is possible to change a spectrum of a first output pulsed light beam P13 transmitted from the first photonic crystal fiber 124.

The polarizing adjuster 120 is constituted by the λ/2 wave plate, changes a polarizing direction of a second pulsed light beam P17 in accordance with the polarization maintaining direction of the second photonic crystal fiber 150, so that it is possible to change a spectrum of a second output pulsed light beam P18 transmitted via the second photonic crystal fiber 150.

The polarizing adjuster 127 is placed downstream of the second photonic crystal fiber 150. The polarizing adjuster 127 is constituted by the polarizing prism, extracts linearly-polarized elements from the second output pulsed light beam P18 which has passed through the second photonic crystal fiber 150, and adjusts a plane of polarization of the second output pulsed light beam P18. Therefore, the second output pulsed light beam P18 can be superimposed on the first output pulsed light beam P13 passing through the first photonic crystal fiber 124 with the planes of polarization matching with each other. Alternatively, the polarizing adjuster 127 may be omitted. In such a case, the planes of polarization of the pulsed light beams P13 and P18 may be adjusted only by the polarizing adjuster 27 placed downstream of the first photonic crystal fiber 124, thereby matching the planes of polarization of the pulsed light beams P13 and P18.

Further, the planes of polarization of the pulsed light beams P11 and P17 are adjusted by the polarizing adjusters 20 and 120 placed upstream of the first and second photonic crystal fibers 124 and 150. Therefore, it is possible to control the spectra of the first and second output pulsed light beams P13 and P18 output from the first and second photonic crystal fibers 124 and 150.

In the sixth embodiment, the first and second photonic crystal fibers 124 and 150 are the polarization maintaining type. The spectra of the light beams P13 and P18 are adjusted by the input light intensity adjuster 19,119, polarizing adjuster 27, 127, phase adjuster 28, 128, and output light intensity adjuster 42, 142. Further, the spectra of the light beams P13 and P18 are controlled by the polarizing adjusters 20 and 120. Therefore, the broadband white light beam P20 produced by the superimposed pulsed light beams P13 and P18 can have the spectrum of which wavelength dependency is more moderate than that of the first output pulsed light beam P13 transmitted via the first photonic crystal fiber 124.

With the sixth embodiment, it is possible to produce the broadband white light beam P20 having the phase information and moderate wavelength dependency of the light intensity. It is possible to suppress variations of signal intensity of a signal detected from an object to be analyzed. Therefore, the sensor having a small dynamic range can be used.

The control unit 60 includes the database 61, input unit 62, and parameter setting unit 63. The database 61 stores a spectrum of the broad band white light beams P20 (detected by the sensor 54) in correspondence with a variety of parameters of the pulsed light splitter 17, input light intensity adjuster 19, 119, polarizing adjusters 20, 120, polarizing adjuster 27,127, phase adjuster 28, 128, output light intensity adjuster 42, 142. The input unit 62 receives information concerning a wavelength band, a light intensity and wavelength dependency of the broadband white light beam P20. The parameter setting unit 63 retrieves from the database 61 a spectrum (which substantially meets input conditions) on the basis of the wavelength band, light intensity, wavelength dependency and so on received via the input unit 62. Further, the parameter setting unit 63 selects the parameters which correspond to the retrieved spectrum, and provides them to the pulsed light splitter 17, input light intensity adjuster 19, 119 polarizing adjusters 20, 120, polarizing adjuster 27,127, phase adjuster 28, 128, output light intensity adjuster 42, 142. Therefore, the broadband white light beam P20 meets requirements entered via the input unit 62.

### (7) Seventh Embodiment

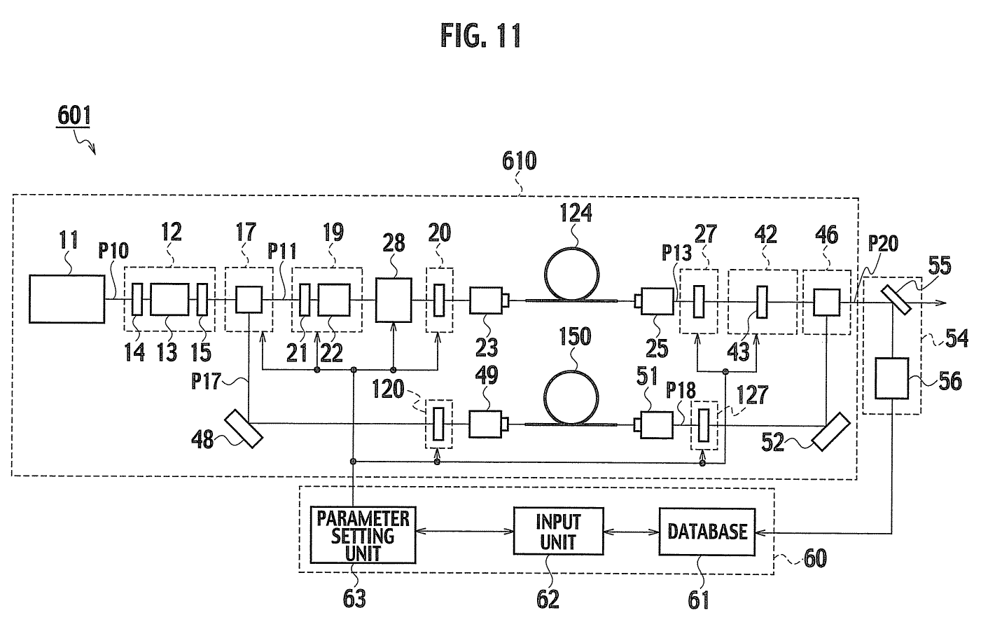

As shown in FIG. 11, a light source system 601 is similar to the light source system 201 (shown in FIG. 7) except for the following: the first and second photonic crystal fibers 124 and 150 are of the polarization maintaining type; the polarizing adjusters 20 and 120 are placed upstream of the first and second photonic crystal fibers 124 and 150; and the polarizing adjuster 127 is placed downstream of the second photonic crystal fiber 150.

The polarizing adjuster 20 is constituted by the A,/2 wave plate, changes a polarizing direction of the first pulsed light beam P11 in accordance with the polarization maintaining direction of the first photonic crystal fiber 124. Further, it is possible to change a spectrum of a first output pulsed light beam P13 transmitted from the first photonic crystal fiber 124.

The polarizing adjuster 120 is constituted by the λ/2 wave plate, changes a polarizing direction of a second pulsed light beam P17 in accordance with the polarization maintaining direction of the second photonic crystal fiber 150, so that it is possible to change a spectrum of a second output pulsed light beam P18 transmitted via the second photonic crystal fiber 150.

The polarizing adjuster 127 is placed downstream of the second photonic crystal fiber 150. The polarizing adjuster 127 is constituted by the polarizing prism, extracts linearly-polarized elements from the second output pulsed light beam P18 which has passed through the second photonic crystal fiber 150, and adjusts a plane of polarization of the second output pulsed light beam P18. Therefore, the second output pulsed light beam P18 can be superimposed on the first output pulsed light beam P13 passing through the first photonic crystal fiber 124 with the planes of polarization matching with each other. Alternatively, the polarizing adjuster 127 may be omitted. In such a case, the planes of polarization of the pulsed light beams P13 and P18 may be adjusted only by the polarizing adjuster 27 placed downstream of the first photonic crystal fiber 124, thereby matching the planes of polarization of the pulsed light beams P13 and P18.

Further, the planes of polarization of the pulsed light beams P11 and P17 are adjusted by the polarizing adjusters 20 and 120 placed upstream of the first and second photonic crystal fibers 124 and 150. Therefore, it is possible to control the spectra of the first and second output pulsed light beams P13 and P18 output from the first and second photonic crystal fibers 124 and 150.

In the seventh embodiment, the first and second photonic crystal fibers 124 and 150 are the polarization maintaining type. The spectra of the pulsed light beams P13 and P18 are adjusted by the input light intensity adjuster 17, phase adjuster 28 and output light intensity adjuster 42. Further, the spectra of the pulsed light beams P13 and P18 are controlled by the polarizing adjusters 20 and 120 which are placed upstream of the first and second photonic fibers 124 and 150. Therefore, when the first and second output pulses P13 and P18 are superimposed, the broadband white light beam P20 produced by the matched light beams P13 and P18 can have the spectrum of which wavelength dependency is more moderate than that of the first output pulsed light beam P13 transmitted via the first photonic crystal fiber 124.

With the seventh embodiment, it is possible to produce the broadband white light beam P20 having the phase information and moderate wavelength dependency of the light intensity. It is possible to suppress variations of signal intensity of a signal detected from an object to be analyzed. Therefore, the sensor having a small dynamic range can be used.

The control unit 60 includes the database 61, input unit 62, and parameter setting unit 63. The database 61 stores a spectrum of the broad band white light beams P20 (detected by the sensor 54) in correspondence with a variety of parameters of the pulsed light splitter 17, input light intensity adjuster 19, polarizing adjusters 20, 120, polarizing adjuster 27,127, phase adjuster 28, output light intensity adjuster 42. The input unit 62 receives information concerning a wavelength band, a light intensity and wavelength dependency of the broadband white light beam P20. The parameter setting unit 63 retrieves from the database 61 a spectrum (which substantially meets input conditions) on the basis of the wavelength band, light intensity, wavelength dependency and so on received via the input unit 62. Further, the parameter setting unit 63 selects the parameters which correspond to the retrieved spectrum, and provides them to the pulsed light splitter 17, input light intensity adjuster 19, polarizing adjusters 20, 120, polarizing adjuster 27,127, phase adjuster 28, output light intensity adjuster 42. Therefore, the broadband white light beam P20 meets requirements entered via the input unit 62.

### (8) Eighth Embodiment

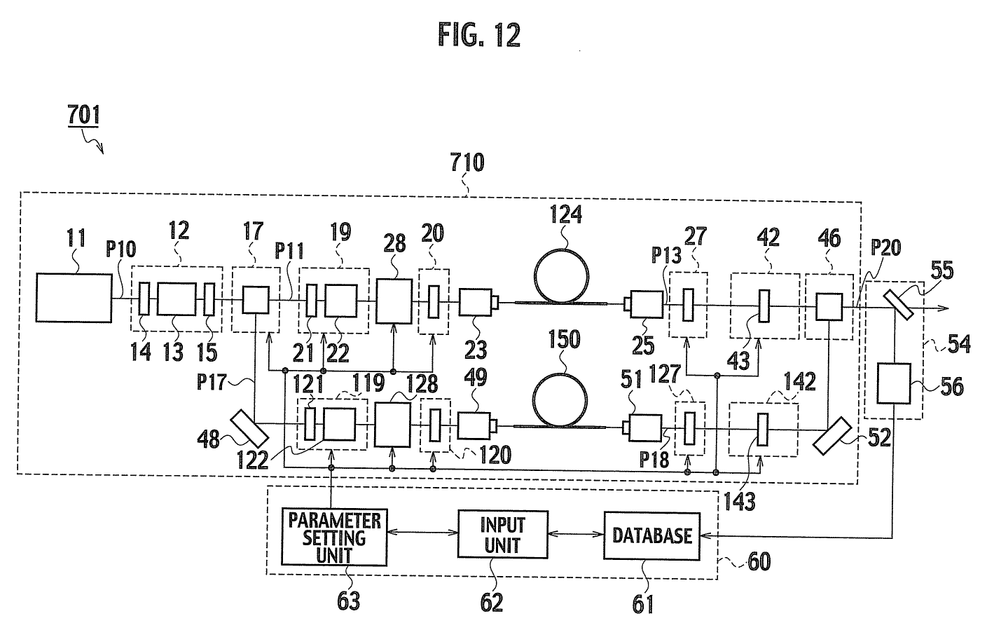

As shown in FIG. 12, a light source system 701 is similar to the light source system 301 (shown in FIG. 8) except for the following: the first and second photonic crystal fibers 124 and 150 are of the polarization maintaining type; the polarizing adjusters 20 and 120 are placed upstream of the first and second photonic crystal fibers 124 and 150; and the polarizing adjuster 127 is placed downstream of the second photonic crystal fiber 150.

The polarizing adjuster 20 is constituted by the λ/2 wave plate, changes a polarizing direction of the first pulsed light beam P11 in accordance with the polarization maintaining direction of the first photonic crystal fiber 124. Further, it is possible to change a spectrum of a first output pulsed light beam P13 transmitted from the first photonic crystal fiber 124.

The polarizing adjuster 120 is constituted by the λ/2 wave plate, changes a polarizing direction of a second pulsed light beam P17 in accordance with the polarization maintaining direction of the second photonic crystal fiber 150, so that it is possible to change a spectrum of a second output pulsed light beam P18 transmitted via the second photonic crystal fiber 150.

The polarizing adjuster 127 is placed downstream of the second photonic crystal fiber 150. The polarizing adjuster 127 is constituted by the polarizing prism, extracts linearly-polarized elements from the second output pulsed light beam P18 which has passed through the second photonic crystal fiber 150, and adjusts a plane of polarization of the second output pulsed light beam P18. Therefore, the second output pulsed light beam P18 can be superimposed on the first output pulsed light beam P13 passing through the first photonic crystal fiber 124 with the planes of polarization matching with each other. Alternatively, the polarizing adjuster 127 may be omitted. In such a case, the planes of polarization of the pulsed light beams P13 and P18 may be adjusted only by the polarizing adjuster 27 placed downstream of the first photonic crystal fiber 124, thereby matching the planes of polarization of the pulsed light beams P13 and P18.

Further, the planes of polarization of the pulsed light beams P11 and P17 are adjusted by the polarizing adjusters 20 and 120 placed upstream of the first and second photonic crystal fibers 124 and 150. Therefore, it is possible to control the spectra of the first and second output pulsed light beams P13 and P18 output from the first and second photonic crystal fibers 124 and 150.

In the eighth embodiment, the first and second photonic crystal fibers 124 and 150 are the polarization maintaining type. The spectra of the pulsed light beams P13 and P18 are adjusted by the input light intensity adjuster 19, 119, phase adjuster 28, 128 and output light intensity adjuster 42, 142. Further, the spectra of the pulsed light beams P13 and P18 are controlled by the polarizing adjusters 20 and 120. Therefore, the broadband white light beam P20 produced by the matched pulsed light beams P13 and P18 can have the spectrum of which wavelength dependency is more moderate than that of the first output pulsed light beam P13 transmitted via the first photonic crystal fiber 124.

With the eighth embodiment, it is possible to produce the broadband white light beam P20 having the phase information and moderate wavelength dependency of the light intensity. It is possible to suppress variations of signal intensity of a signal detected from an object to be analyzed. Therefore, the sensor having a small dynamic range can be used.

The control unit 60 includes the database 61, input unit 62, and parameter setting unit 63. The database 61 stores a spectrum of the broad band white light beams P20 (detected by the sensor 54) in correspondence with a variety of parameters of the pulsed light splitter 17, input light intensity adjuster 19, 119, polarizing adjusters 20, 120, polarizing adjuster 27,127, phase adjuster 28, 128, output light intensity adjuster 42, 142. The input unit 62 receives information concerning a wavelength band, a light intensity and wavelength dependency of the broadband white light beam P20. The parameter setting unit 63 retrieves from the database 61 a spectrum (which substantially meets input conditions) on the basis of the wavelength band, light intensity, wavelength dependency and so on received via the input unit 62. Further, the parameter setting unit 63 selects the parameters which correspond to the retrieved spectrum, and provides them to the pulsed light splitter 17, input light intensity adjuster 19, 119, polarizing adjusters 20, 120, polarizing adjuster 27,127, phase adjuster 28, 128, output light intensity adjuster 42, 142. Therefore, the broadband white light beam P20 meets requirements entered via the input unit 62.

### (9) Other Embodiments

In the foregoing description, the control unit 60 is utilized to produce the broadband white light beam P20 having the target spectrum. Alternatively, a variety of parameters may be manually set in order to produce such a broadband white light beam P20.

What is claimed is:

1. A light source comprising:
a light source unit producing a first pulsed light beam having a plurality of frequency components;
a splitter splitting the first pulsed light beam into second and third pulsed light beams;
a first photonic crystal fiber converting the split second pulsed light beam into a wider bandwidth;
a second photonic crystal fiber converting the split third pulsed light beam into a wider bandwidth;
a first adjuster adjusting a spectrum of the second pulsed light beam converted into the wider bandwidth;
a phase adjuster matching phases of the second and third pulsed light beams converted into the wider bandwidth; and
a superimposing unit superimposing the second pulsed light beam having the adjusted spectrum and the third pulsed light beam converted into the wider bandwidth.

2. The light source defined in claim 1, further comprising a second adjuster adjusting a spectrum of the third pulsed light beam converted into the wider bandwidth, wherein the superimposing unit superimposing the second pulsed light beam converted into the wider bandwidth and has the spectrum thereof adjusted by the first adjuster and the third pulsed light beam converted into the wider bandwidth and has the spectrum thereof adjusted by the second adjuster.

3. The light source defined in claim 1, wherein the first adjuster adjusts a light intensity of the second pulsed light beam arriving at the first photonic crystal fiber.

4. The light source defined in claim 3, wherein the first adjuster adjusts a phase of the second pulsed light beam arriving at the first photonic crystal fiber.

5. The light source defined in claim 2, wherein the second adjuster adjusts a light intensity of the third pulsed light beam arriving at the second photonic crystal fiber.

6. The light source defined in claim 5, wherein the second adjuster adjusts a phase of the third pulsed light beam arriving at the second photonic crystal fiber.

7. The light source defined in claim 1, wherein the phase adjuster adjusts a phase of the second pulsed light beam converted into the wider bandwidth.

8. The light source defined in claim 1, wherein the phase adjuster adjusts a phase of the second pulsed light beam arriving at the first photonic crystal fiber.

9. The light source defined in claim 7, wherein the phase adjuster adjusts a phase of the third pulsed light beams converted into the wider bandwidth.

10. The light source defined in claim 8, wherein the phase adjuster adjusts a phase of the third pulsed light beam arriving at the second photonic crystal fiber.

11. The light source defined in claim 1, further comprising a polarizing adjuster which matches a plane of polarization of the second pulsed light beam converted into the wider broadband with a plane of polarization of the third pulsed light beam converted into the wider bandwidth.

12. The light source defined in claim 2, further comprising a polarizing adjuster which matches a plane of polarization of the second pulsed light beam converted into the wider broadband with a plane of polarization of the third pulsed light beam converted into the wider bandwidth.

13. The light source defined in claim 11, wherein the polarizing adjuster adjusts a plane of polarization of the second pulsed light beam converted into the wider bandwidth.

14. The light source defined in claim 12, wherein the polarizing adjuster adjusts a plane of polarization of the second pulsed light beam converted into the wider bandwidth.

15. The light source defined in claim 11, wherein the polarizing adjuster adjusts a plane of polarization of the second pulsed light beam arriving at the first photonic crystal fiber.

16. The light source defined in claim 12, wherein the polarizing adjuster adjusts a plane of polarization of the second pulsed light beam arriving at the first photonic crystal fiber.

17. The light source defined in claim 15, wherein the polarizing adjuster adjusts a plane of polarization of the third pulsed light beam arriving at the second photonic crystal fiber.

18. The light source defined in claim 16, wherein the polarizing adjuster adjusts a plane of polarization of the third pulsed light beam arriving at the second photonic crystal fiber.

19. A light source system comprising:
a light source unit producing a first pulsed light beam having a plurality of frequency components;
a splitter splitting the first pulsed light beam into second and third pulsed light beams;
a first photonic crystal fiber converting the split second pulsed light beam into a wider bandwidth;
a second photonic crystal fiber converting the split third pulsed light beam into a wider bandwidth;
a first adjuster adjusting a spectrum of the second pulsed light beam converted into the wider bandwidth;
a phase adjuster matching phases of the second and third pulsed light beams converted into the wider bandwidth;
a superimposing unit superimposing the second pulsed light beam having the adjusted spectrum and the third pulsed light beam converted into the wider bandwidth;
a sensor detecting a spectrum of a white broadband light beam transmitted by the superimposing unit; and
a control unit adjusting the first adjuster on the basis of the spectrum detected by the sensor.

20. The light source system defined in claim 19, further comprising a second adjuster adjusting a spectrum of the third pulsed light beam converted into the wider bandwidth, wherein the superimposing unit superimposing the second pulsed light beam converted into the wider bandwidth and has the spectrum thereof adjusted by the first adjuster and the third pulsed light beam converted into the wider bandwidth and has the spectrum thereof adjusted by the second adjuster;
and the control unit adjusts the second adjuster on the basis of the spectrum detected by the sensor.
